(19) United States
(12) Patent Application Publication
(10) Pub. No.: US 2024/0151553 A1
(43) Pub. Date: May 9, 2024

(54) AUTONOMOUS TRAVEL ASSISTANCE DEVICE

(71) Applicant: Mitsubishi Electric Corporation, Tokyo (JP)

(72) Inventors: Ryosuke NISHIMURA, Tokyo (JP); Toru HIGUCHI, Tokyo (JP); Yuta WADA, Tokyo (JP)

(73) Assignee: Mitsubishi Electric Corporation, Tokyo (JP)

(21) Appl. No.: 18/279,510

(22) PCT Filed: Apr. 2, 2021
(86) PCT No.: PCT/JP2021/014280

§ 371 Date: Aug. 30, 2023

(51) Int. Cl. G01C 21/00; B60W 30/18; B60W 60/00; G01C 21/34; G01C 21/36

(52) U.S. Cl. CPC G01C 21/3896; B60W 30/18159; B60W 60/001; G01C 21/3453; G01C 21/3658; G01C 21/3815; B60W 2552/53; B60W 2556/40; B60W 2556/45

(57) ABSTRACT

Provided is an autonomous travel assistance device including a server device. The server device receives road state information from a roadside unit. The server device stores map information as a combination of a plurality of nodes and a plurality of links. The server device holds route information on a target vehicle. The server device receives, from the target vehicle, vehicle information on a position and a travel state of the target vehicle, selects a part of the nodes as a selected node based on the vehicle information and the route information, and selects a part of the links as a selected link based thereon. The server device transmits, as dynamic map information, information obtained by adding the road state information on the selected node and the selected link to the map information, to the target vehicle that autonomously travels along a planned travel route.

### TECHNICAL FIELD

This disclosure relates to an autonomous travel assistance device.

### BACKGROUND ART

In a related-art method of incorporating a dynamic object into a digital map of a self-driving vehicle, the digital map is delivered to the self-driving vehicle, and the delivered digital map is used for travel assistance for the self-driving vehicle. The digital map is map data obtained by superimposing dynamic road information on a map. The dynamic road information includes, for example, information on other vehicles on a travel route, traffic signal information on roads, and congestion information (see, for example, Patent Literature 1).

### CITATION LIST

### Patent Literature

[PTL 1] U.S. Ser. No. 10/605,612 B2

### SUMMARY OF INVENTION

### Technical Problem

In the related-art method as described above, there is a fear that information included in the dynamic road information may be insufficient, and hence appropriate drive assistance may be difficult.

This disclosure has been made in order to solve the above-mentioned problem, and has an object to provide an autonomous travel assistance device capable of more appropriately executing autonomous travel assistance for a vehicle.

### Solution to Problem

According to one embodiment of this disclosure, there is provided an autonomous travel assistance device including a server device configured to receive, from a roadside unit, road state information that is information on a state of a periphery of the roadside unit, and to transmit dynamic map information that is information obtained by adding the road state information to map information, to a target vehicle that autonomously travels along a planned travel route, wherein the server device stores the map information as a combination of a plurality of nodes and a plurality of links, wherein each of the plurality of nodes corresponds to an intersection, wherein each of the plurality of links corresponds to a road connecting between two intersections next to each other, and wherein the server device is configured to: hold route information that is information on the travel route; receive, from the target vehicle, vehicle information that is information on a position of the target vehicle and information on a travel state of the target vehicle; select, as a selected node, a part of the plurality of nodes based on the vehicle information and the route information, and select, as a selected link, a part of the plurality of links based on the vehicle information and the route information; and transmit, to the target vehicle as the dynamic map information, information obtained by adding the road state information on the selected node and the selected link to the map information.

### Advantageous Effects of Invention

According to the autonomous travel assistance device of this disclosure, the autonomous travel assistance for a vehicle can more appropriately be executed.

### BRIEF DESCRIPTION OF DRAWINGS

FIG. 1 is a block diagram for illustrating an autonomous travel assistance device, a server device, a roadside unit, and a vehicle in a first embodiment of this disclosure.

FIG. 2 is a view for illustrating a state of an intersection to which the autonomous travel assistance device of FIG. 1 is applied.

FIG. 3 is a flowchart for illustrating an autonomous travel assistance control routine executed by a control unit of the autonomous travel assistance device of FIG. 1.

FIG. 4 is a diagram for illustrating arrival costs in an autonomous travel assistance device according to a second embodiment of this disclosure.

FIG. 5 is a diagram for illustrating the arrival costs in the autonomous travel assistance device according to the second embodiment.

FIG. 6 is a flowchart for illustrating an autonomous travel assistance control routine executed by the control unit of the autonomous travel assistance device according to the second embodiment.

FIG. 7 is a view for illustrating an example of control executed by an autonomous travel assistance device according to a third embodiment of this disclosure.

FIG. 8 is a view for illustrating an example of the control executed by the autonomous travel assistance device according to the third embodiment.

FIG. 9 is a configuration diagram for illustrating a first example of a processing circuit that implements functions of the autonomous travel assistance device according to the first embodiment to the third embodiment.

FIG. 10 is a configuration diagram for illustrating a second example of a processing circuit that implements the functions of the autonomous travel assistance device according to the first embodiment to the third embodiment.

### DESCRIPTION OF EMBODIMENTS

Now, embodiments of this disclosure are described with reference to the drawings.

### First Embodiment

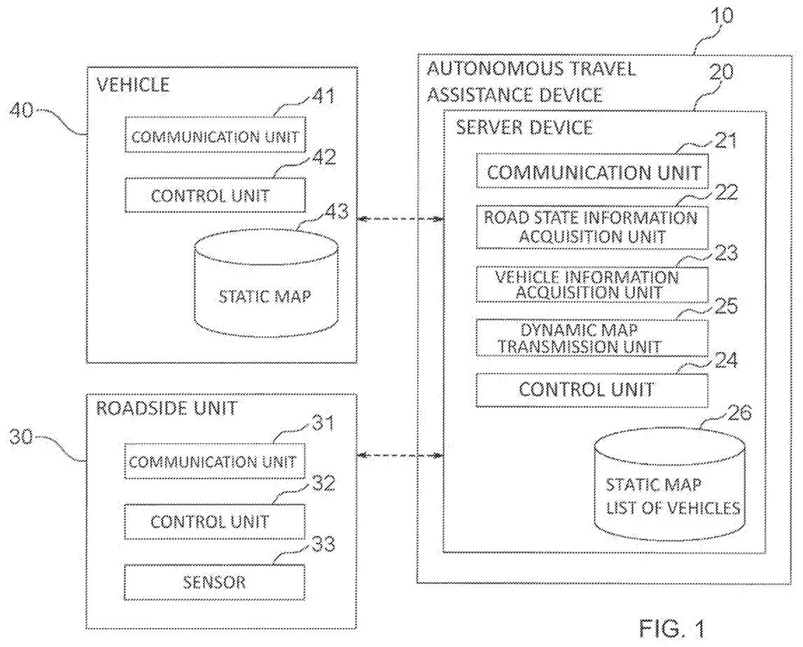

FIG. 1 is a block diagram for illustrating an autonomous travel assistance device, a server device, a roadside unit, and a vehicle in a first embodiment of this disclosure.

An autonomous travel assistance device 10 includes a server device 20. The server device 20 includes, as function blocks, a communication unit 21, a road state information acquisition unit 22, a vehicle information acquisition unit 23, a control unit 24, a dynamic map transmission unit 25, and a storage unit 26.

As the server device 20, for example, a server arranged in a core network of a cellular phone network called “multi-access edge computing (MEC)” is used. Moreover, a network specially built for use within a limited area such as a plant may be used for the server device 20. For example, the server device 20 may be connected to a network which can be connected to a 5G network only within limited premises.

The communication unit 21 receives road state information from a roadside unit 30. The road state information is information detected by a sensor 33 of the roadside unit 30, and is information on a state around the roadside unit 30. Examples of the information on the state around the roadside unit 30 include information on traveling vehicles, information on stopped vehicles, information on parked vehicles, information on pedestrians, information on obstacles, and information on a road surface state.

Examples of the sensor 33 include a camera, millimeter wave radar, and a light detection and ranging (LiDAR) sensor. Moreover, for communication between the server device 20 and the roadside unit 30, wireless communication or wired communication is used. For the wired communication, an optical fiber, a LAN cable, or the like is used.

The communication unit 21 receives vehicle information from a vehicle 40 as a target vehicle. The target vehicle is a vehicle which autonomously travels along a planned travel route, and a vehicle which is a target of the autonomous travel assistance. The vehicle information is information on a position of the vehicle 40 and information on a travel state of the vehicle 40. The information on the travel state of the vehicle 40 includes at least a part of a speed of the vehicle 40, an acceleration of the vehicle 40, a travel history of the vehicle 40, a turn signal information on the vehicle 40, and a planned travel path of the vehicle 40.

A communication unit 41 of the vehicle 40 includes a communication device which can execute wireless communication and an antenna. For the wireless communication, the Cellular V2X (C-V2X) which uses the Long Term Evolution (LTE) (trademark), the 5G, and the like is employed. Moreover, wireless communication which uses the Over The Air (OTA), wireless communication compliant to the Wi-Fi standard, or the like may sometimes be used. The communication unit 41 transmits the vehicle information and the route information to the server device 20 at constant cycles.

The road state information acquisition unit 22 acquires the road state information from the roadside unit 30 via the communication unit 21.

The vehicle information acquisition unit 23 acquires the vehicle information from the vehicle 40 via the communication unit 21.

The storage unit 26 stores map information as combinations of a plurality of nodes and a plurality of links. Each of the nodes corresponds to an intersection. Each of the links corresponds to a road connecting between two intersections next to each other. The intersection includes a three-way intersection, a crossroad, a five-way intersection, a roundabout, and the like.

The storage unit 26 holds the route information on the vehicle 40. The route information is information on the travel route of the vehicle 40. The server device 20 holds the route information on the target vehicle in the storage unit 26 in association with lane information. The lane information is information on lanes of a road. For example, the server device 20 can hold not only the information on the link on which the target vehicle is traveling, but also information on a lane in which the target vehicle is traveling among a plurality of lanes of a road corresponding to this link.

Further, the storage unit 26 stores list information on the target vehicles of the autonomous travel assistance. The control unit 24 periodically executes processing of transmitting dynamic map information to each vehicle included in the list information.

The control unit 24 selects, as a selected node, a part of the plurality of nodes and selects, as a selected link, a part of the plurality of links based on the received vehicle information and the held route information.

The control unit 24 generates the dynamic map information based on the road state information on the selected node and the selected link of the acquired road state information and the map information stored in the storage unit 26. The dynamic map information is information obtained by adding the road state information to the map information. For example, the dynamic map information is data indicating positions of pedestrians, movement routes of the pedestrians, point cloud data indicating a travel route of the vehicle 40 within a certain time, and positions of stopped or parked vehicles, constructions, and obstacles on the road.

The dynamic map transmission unit 25 transmits the information generated in the control unit 24 to the vehicle 40 as the dynamic map information.

A control unit 32 of the roadside unit 30 acquires, for example, the road state information around the roadside unit 30 from the sensor 33, and outputs the road state information to a communication unit 31. The communication unit 31 transmits the acquired road state information to the server device 20. Moreover, a control unit 42 of the vehicle 40 controls, based on the vehicle information and the road state information received from the server device 20, a driving device, a braking device, a steering device, and the like of the vehicle 40, which are not shown, to thereby cause the vehicle 40 to autonomously travel.

When the vehicle 40 receives the dynamic map information, the received dynamic map information is superimposed on the map information stored in a storage unit 43 of the vehicle 40, and is then used to determine acceleration and deceleration, stop, and the like of the vehicle 40. The server device 20 refers to the position information included in the vehicle information received from the target vehicle to which the dynamic map information is to be transmitted and the map information stored in the storage unit 26, to thereby acquire a link or a node on which the vehicle 40 is traveling.

The map information stored in the server device 20 and the vehicle 40 is static map information. The static map information includes a terrain, road information, and the like. As the static map information, for example, the Geographic Data Files 5.0 (GDF 5.0), which is one of the international standards for the road map, is used, but a map based on another international standard or a unique standard may be used.

Moreover, in FIG. 1, only the one roadside unit 30 and the one vehicle 40 are illustrated, but the one server device 20 is capable of communicating to and from a plurality of roadside units and a plurality of vehicles in the first embodiment. Thus, the communication unit 21 similarly receives vehicle information also from vehicles which are not the target vehicles. In this case, the communication unit 21 asynchronously and periodically receives the vehicle information from the plurality of vehicles 40, and asynchronously and periodically receives the road state information from the plurality of roadside units 30.

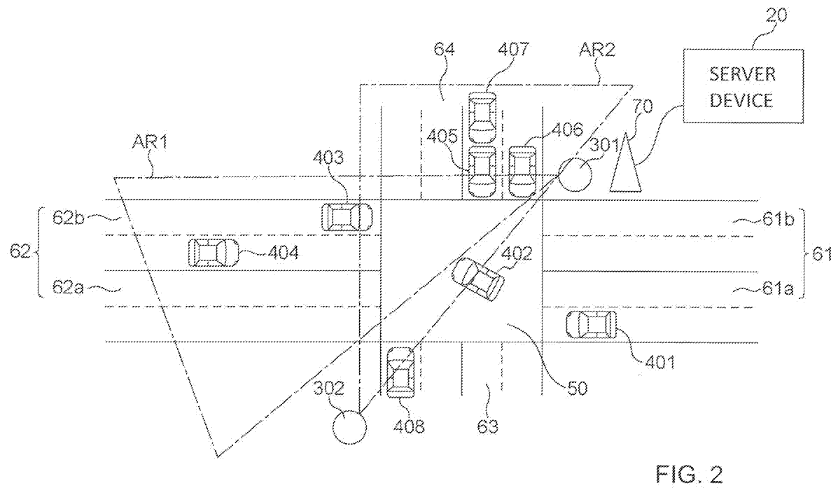

FIG. 2 is a view for illustrating a state of an intersection to which the autonomous travel assistance device 10 of FIG. 1 is applied. To an intersection 50 illustrated in FIG. 2, four roads 61, 62, 63, and 64 are connected. That is, in this example, four links are connected to one node. The intersection 50 is hereinafter also referred to as “node #1.” Moreover, the roads 61, 62, 63, and 64 are also referred to as “link #1,” “link #2,” “link #3,” and “link #4,”, respectively.

The roads 61, 62, 63, and 64 are roads each having two lanes on each side for left-hand driving. The road 62 exists on an extension of the road 61. That is, a vehicle traveling on the road 61 can enter the road 62 by traveling straight. A vehicle traveling on the road 62 can enter the road 61 by traveling straight.

On roadsides of the intersection 50, a first roadside unit 301 and a second roadside unit 302 are installed. Although illustration is omitted, a sensor is provided to each of the first roadside unit 301 and the second roadside unit 302. Each of the sensors corresponds to the sensor 33 of FIG. 1. Each of the sensors detects the road state information.

A detectable area AR1 of the sensor of the first roadside unit 301 is an area including a part of the intersection 50, a part of the road 62, and a part of the road 64. The sensor of the first roadside unit 301 mainly detects a state of the road 62. A detectable area AR2 of the sensor of the second roadside unit 302 is an area including a part of the intersection 50, a part of the road 62, a part of the road 63, and a part of the road 64. The sensor of the second roadside unit 302 mainly detects a state of the road 64.

In FIG. 2, eight vehicles 401 to 408 are traveling or stopped. The vehicle 401 is traveling straight on a travel lane 61a of the road 61, that is, toward a left direction of FIG. 2. The vehicle 402 is turning right at the intersection 50 after having traveled on the travel lane 61a of the road 61, and is entering the road 64. The vehicle 403 and the vehicle 404 are traveling straight on an opposite lane 62b of the road 62, that is, toward a right direction of FIG. 2. The vehicles 405, 406, and 407 are stopped to wait for a traffic signal to change on the road 64. The vehicle 408 is stopped to wait for a traffic signal to change on the road 63.

Moreover, a base station 70 is installed near the intersection 50. The base station 70 relays communication between the server device 20 and the first roadside unit 301, communication between the server device 20 and the second roadside unit 302, and communication between the server device 20 and the vehicle 402. The relay performed by the base station 70 is not always required, and hence the base station 70 is not required to exist. In this case, each of the first roadside unit 301, the second roadside unit 302, and the vehicle 402 is only required to directly communicate to and from the server device 20.

The sensor of the first roadside unit 301 can detect the vehicle 403 and the vehicle 404. The server device 20 receives the road state information on the road 62 from the first roadside unit 301 via the base station 70. Thus, the road state information on the road 62 includes information on the vehicle 403 and the vehicle 404.

The sensor of the second roadside unit 302 can detect the vehicle 405, the vehicle 406, and the vehicle 407. The server device 20 receives the road state information on the road 64 from the second roadside unit 302 via the base station 70. Thus, the road state information on the road 64 includes information on the vehicle 405, the vehicle 406, and the vehicle 407.

Now, there is considered a case in which the vehicle 402 is a vehicle which can autonomously travel, and is a target vehicle to which the dynamic map information is to be transmitted by the server device 20. A travel route of the vehicle 402 is “the road 61→the intersection 50→the road 64,” that is, “the link #1→the node #1→the link #4.”

The vehicle 403 and the vehicle 404 are traveling on the link #2 which is on an extension of the link #1 on which the vehicle 402 has traveled, and are traveling on the lane 62b opposite to the travel lane 61a of the vehicle 402 toward the direction toward the vehicle 402. Such a travel mode of the vehicle 403 and the vehicle 404 is referred to as “first travel mode.”

The vehicles 405, 406, and 407 detected by the sensor of the second roadside unit 302 are vehicles on the travel route of the vehicle 402, but the road 64 does not exist on the extension of the link on which the vehicle 402 has traveled.

The control unit 24 of the server device 20 acquires the road state information on the road 62 from the first roadside unit 301 via the base station 70. The road state information on the road 62 includes the information on the vehicle 403 and the vehicle 404. Moreover, the control unit 24 acquires the vehicle information on the vehicle 402 from the vehicle 402 via the base station 70. Further, the control unit 24 acquires the map information from the storage unit 26. After that, the control unit 24 determines that the vehicle 403 and the vehicle 404 are traveling in the above-mentioned “first travel mode” based on the road state information on the road 62, the vehicle information on the vehicle 402, and the map information.

Moreover, the control unit 24 acquires the road state information on the road 64 from the second roadside unit 302 via the base station 70. The road state information on the road 64 includes the information on the vehicles 405, 406, and 407. The control unit 24 determines that the travel modes of the vehicles 404, 406, and 407 do not correspond to the above-mentioned “first travel mode” based on the road state information on the road 64, the vehicle information on the vehicle 402, and the map information.

In a case of this example, the control unit 24 adds the road state information from the first roadside unit 301 to the static map information, but does not add the road state information from the second roadside unit 302 to the static map information. After that, the dynamic map transmission unit 25 of the server device 20 transmits, to the vehicle 402 as the dynamic map information, the map information to which the road state information from the first roadside unit 301 is added.

When a communication unit of the vehicle 402 receives the dynamic map information from the server device 20, the control unit of the vehicle 402 assists in the autonomous travel of the vehicle 402 based on the received dynamic map information. For example, the control unit of the vehicle 402 stops the vehicle 402 until the vehicle 403 and the vehicle 404 pass the intersection 50, and causes the vehicle 402 to turn right after the vehicle 403 and the vehicle 404 pass the intersection 50.

In the example illustrated in FIG. 2, the vehicle 402 which is the target vehicle is traveling on the node, but the target vehicle may be traveling on a link. Thus, the autonomous travel assistance device 10 according to the first embodiment determines whether the target vehicle is traveling on a node or traveling on a link, to thereby change a range of the road state information to be added to the map information as the dynamic map information.

For example, when the vehicle 40 is traveling on a node, the server device 20 adds road state information included in a range of the map corresponding to this node and links adjacent to this node to the map information, and transmits the information obtained through the addition to the vehicle 40 as the dynamic map information.

Meanwhile, when the vehicle 40 is traveling on a link, the server device 20 adds road state information included in a range of the map corresponding to this link, a node at which the target vehicle arrives next, and links adjacent to this node to the map information, and transmits the information obtained through the addition to the vehicle 40 as the dynamic map information.

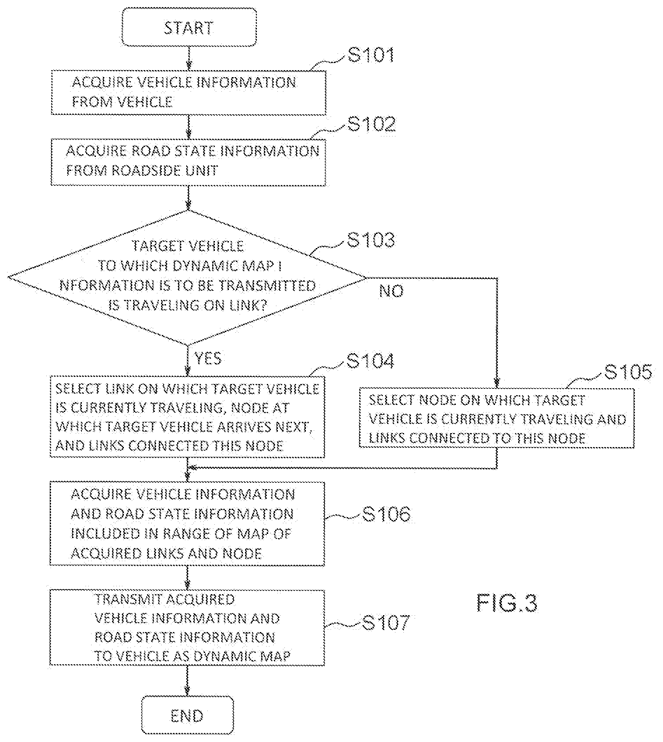

Moreover, in the example illustrated in FIG. 2, the road state information on the link on which the vehicles corresponding to the first travel mode exist is selected. However, all pieces of road state information on links connected to the node on which the target vehicle is currently traveling or all pieces of road state information on links connected to the node on which the target vehicle is planned to travel next may be added to the map information. With reference to FIG. 3, description is given of processing executed in the control unit 24 of the server device 20 in those cases.

FIG. 3 is a flowchart for illustrating an autonomous travel assistance routine executed by the control unit 24 of the autonomous travel assistance device 10 of FIG. 1. The routine of FIG. 3 is started, for example, when an ignition key switch of the vehicle is turned on, and is executed each time a predetermined period has elapsed.

When the control unit 24 starts the routine of FIG. 3, in Step S101, the control unit 24 first acquires the vehicle information on the vehicle 40 from the vehicle 40.

After that, in Step S102, the control unit 24 acquires the road state information from the roadside unit 30.

After that, in Step S103, the control unit 24 determines whether or not the target vehicle to which the dynamic map information is to be transmitted is traveling on a link. When the target vehicle to which the dynamic map information is to be transmitted is traveling on a link, in Step S104, the control unit 24 selects, as the selected links, the link on which the target vehicle is currently traveling and links connected to a node at which the target vehicle arrives next. Moreover, the control unit 24 selects, as the selected node, a node at which the target vehicle arrives next.

Meanwhile, when the target vehicle to which the dynamic map information is to be transmitted is not traveling on a link, that is, when the target vehicle is traveling on a node, in Step S105, the control unit 24 selects, as the selected links, links connected to the node on which the target vehicle is currently traveling. Moreover, the control unit 24 selects, as the selected node, the node on which the target vehicle is currently traveling.

After that, in Step S106, the control unit 24 acquires the vehicle information and the road state information included in the range of the map of the acquired links and node.

After that, in Step S107, the control unit 24 transmits, as the dynamic map information, the acquired vehicle information and road state information to the target vehicle 40, and temporarily finishes this routine.

As described above, the autonomous travel assistance device 10 according to the first embodiment includes the server device 20. The server device 20 receives the road state information from the roadside unit 30, and transmits the dynamic map information to the vehicle 40 as the target vehicle. The server device 20 stores the map information as the combination of the plurality of nodes and the plurality of links. Moreover, the server device 20 holds the route information on the target vehicle. The server device 20 receives the vehicle information from the vehicle 40. The server device 20 selects, as the selected node, a part of the plurality of nodes and selects, as the selected link, a part of the plurality of links based on the route information and the received vehicle information. The server device 20 transmits, to the vehicle 40 as the dynamic map information, the information obtained by adding the road state information on the selected node and the selected link to the map information.

With this autonomous travel assistance device 10, the dynamic information of the dynamic map information includes the information on the routes other than the travel route of the target vehicle, and hence it is possible to suppress occurrence of a situation in which appropriate autonomous travel assistance cannot be executed due to deficiency in information.

Moreover, with this autonomous travel assistance device 10, the dynamic map information transmitted from the server device 20 to the target vehicle does not include information unnecessary for the travel assistance for the target vehicle. Thus, there is no fear that, in the control unit of the target vehicle, a calculation processing load may increase due to a large amount of information and control may consequently be delayed, and unnecessary information may form noise, resulting in generation of an error in a calculation result. That is, with this autonomous travel assistance device 10, the autonomous travel assistance for vehicles can more appropriately be executed.

Moreover, with this autonomous travel assistance device 10, when the target vehicle is traveling on one link of a plurality of links, the selected links are links satisfying the following condition 1.

Condition 1: one link on which the target vehicle is currently traveling and one or more links that are different from the one link, are connected to the one link, and are connected to a node at which the target vehicle arrives next.

Further, the selected node is a node which is connected to the one link on which the target vehicle is currently traveling and at which the target vehicle arrives next.

Meanwhile, when the target vehicle is traveling on one node of the plurality of nodes, the selected link is a link that is connected to the one node on which the target vehicle is currently traveling and is different from a link which the target vehicle has passed. Further, the selected node is the one node on which the target vehicle is currently traveling.

As a result, the autonomous travel assistance for the target vehicle can more appropriately be executed regardless of whether the target vehicle is traveling on a link or traveling on a node.

Moreover, with this autonomous travel assistance device 10, the server device 20 holds the route information in association with the lane information which is information on lanes of roads. With this configuration, for example, a vehicle traveling on an oncoming lane can be held while this vehicle is distinguished from vehicles traveling on other lanes, and hence the autonomous travel assistance for vehicles can more appropriately be executed.

### Second Embodiment

Description is now given of an autonomous travel assistance device according to a second embodiment of this disclosure. In the second embodiment, an arrival cost is defined for each link of the map information defined by the links and the nodes. The arrival cost is obtained by converting, to a numerical value, difficulty in movement of a vehicle between two nodes to which one link is connected. For example, as the distance of the link becomes longer, the arrival cost tends to increase. Moreover, for example, when a congestion occurs in the link, the arrival cost increases.

Herein, the arrival cost is defined as a cost which is calculated as a cost required for the movement based on an average movement time required to move between two nodes and the distance between the two nodes. In other words, the arrival cost is relative weighting to each link.

A configuration other than the introduction of the arrival cost is the same as the configuration of the autonomous travel assistance device 10 according to the first embodiment.

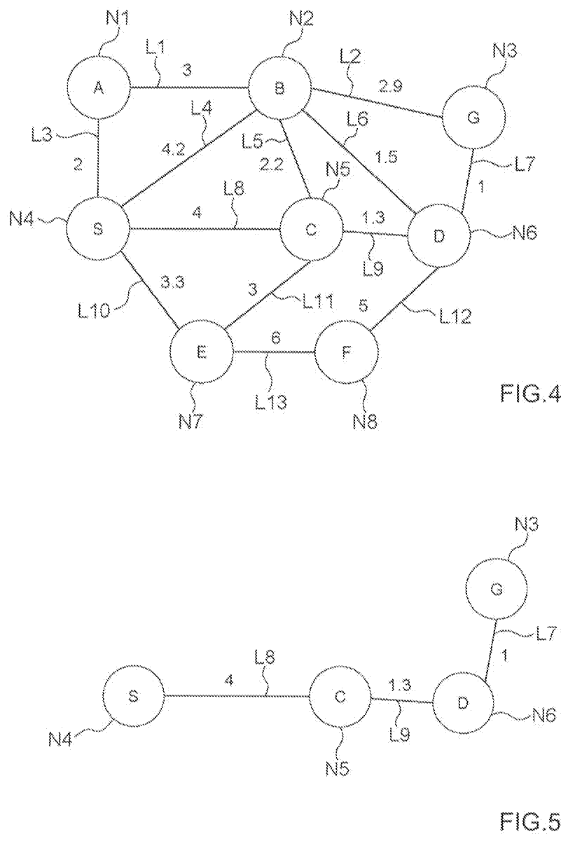

FIG. 4 is a diagram for illustrating the arrival costs in the autonomous travel assistance device according to the second embodiment. In FIG. 4, there are illustrated eight nodes N1 to N8 and thirteen links L1 to L13 connected thereto. Between the node N1 and the node N2, the link L1 is connected. The arrival cost of the link L1 is 3. Between the node N7 and the node N8, the link L13 is connected. The arrival cost of the link L13 is 6.

For example, when the arrival cost is determined based on time, the link L13 indicates that the time for movement thereon is twice as long as that of the link L1. Moreover, when the arrival cost is determined based on the distance, the link L13 indicates that the distance thereof is twice as long as that of the link L1.

Moreover, for example, an arrival cost at the time when a vehicle moves from the node N1 to the node N3 via the node N2, that is, an arrival cost of a route “A→B→G” is calculated as a total value of the arrival cost of the link L1 and the arrival cost of the link L2. In this example, the total value of the arrival costs is calculated as an integrated value of the arrival costs. That is, the arrival cost of the route “A→B→G” is 5.9.

FIG. 5 is a diagram for illustrating the arrival costs in the autonomous travel assistance device according to the second embodiment. A route “S→C→D→G” illustrated in FIG. 5 is a route which has the minimum total value of the arrival costs when the vehicle moves from the node N4 which is a start point of the vehicle to the node N3 which is a destination of the vehicle. In the case of this example, the vehicle passes the link L8, the link L9, and the link L7, and hence the total value of the arrival costs is 6.3.

The server device 20 in the second embodiment determines the selected node and the selected link based on the vehicle information on the target vehicle, the route information on the target vehicle, and the arrival cost of each link. For example, links in a range in which a total value of the arrival cost of the link on which the target vehicle is currently traveling and arrival costs of links starting from a node at which the target vehicle arrives next is equal to or less than a determination value are selected as the selected links. When the arrival cost of the link on which the target vehicle is currently traveling exceeds the determination value, only this link is selected as the selected link.

With reference to FIG. 4, description is now given of an example of a case in which the determination value is set to “4,” and the vehicle travels on the route “S→C→D→G.” When the vehicle has started from the node N4, and is traveling on the link L8, the arrival cost of the traveled link is 4. Thus, the server device 20 selects only the traveled link as the selected link.

After that, the arrival cost of the traveled link at the time when the vehicle is traveling on the link L9 is 1.3, which is smaller than the determination value by 2.7. In this case, the server device 20 selects, as the selected links, links each of which has an arrival cost of 2.7 or less among the links connected to the node N6 at which the vehicle arrives next. Thus, the server device 20 selects, as the selected links, the link L9, the link L6 having an arrival cost of 1.5, and the link L7 having an arrival cost of 1.

The arrival cost of the traveled link at the time when the vehicle is traveling on the link L7 is 1, which is smaller than the determination value by 3. In this case, the server device 20 selects, as the selected links, links each of which has an arrival cost of 3 or less among the links connected to the node N3 at which the vehicle arrives next. Thus, the server device 20 selects, as the selected links, the link L7 and the link L2 having an arrival cost of 2.9.

When it is assumed that both of the costs of the link L12 and the link L13 are 1, and the vehicle is traveling on the link L9, the total value of the arrival cost of the link L9, the arrival cost of the link L12, and the arrival cost of the link L13 is 3.3, which is less than the determination value. Thus, in this case, the server device 20 selects, in addition to the links L9, L6, and L7, the link L12 and the link L13 as the selected links.

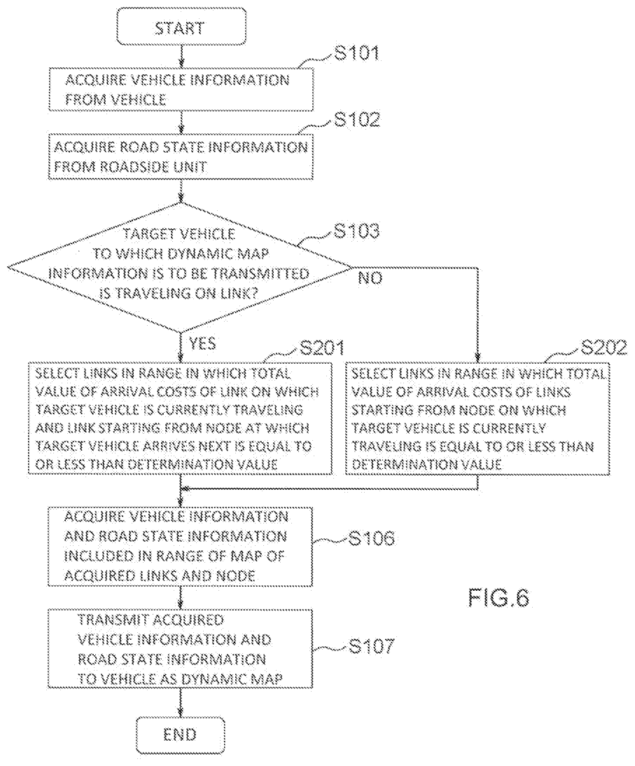

FIG. 6 is a flowchart for illustrating an autonomous travel assistance routine executed by the control unit 24 of the autonomous travel assistance device 10 according to the second embodiment. The routine of FIG. 6 is started, for example, when the ignition key switch of the vehicle is turned on, and is executed each time a predetermined period has elapsed. In FIG. 6, the same step numbers are assigned to the same steps as the steps of the routine of FIG. 3. Description of the same steps are omitted.

When the control unit 24 of the autonomous travel assistance device starts the routine, the control unit 24 executes the processing steps of from Step S101 to Step S103.

When the target vehicle to which the dynamic map information is to be transmitted is traveling on a link, the control unit 24 selects the selected link in Step S201 as described below. The control unit 24 selects, as the selected links, links in the range in which the total value of the arrival costs of the link on which the target vehicle is currently traveling and the links starting from a node at which the target vehicle arrives next is equal to or less than the determination value.

Meanwhile, when the target vehicle to which the dynamic map information is to be transmitted is not traveling on a link, that is, when the target vehicle is traveling on a node, the control unit 24 selects the selected link in Step S202 as described below. The control unit 24 selects, as the selected links, links in the range in which the total value of the arrival costs of the links starting from the node on which the target vehicle is currently traveling is equal to or less than the determination value. Moreover, the control unit 24 selects, as the selected nodes, nodes at which the target vehicle arrives next and nodes between the selected links.

After the execution of the processing step of Step S104 or the processing step of Step S105, the control unit 24 sequentially executes the processing step of Step S106 and the processing step of Step S107, and temporarily finishes this routine.

As described above, the autonomous travel assistance device 10 according to the second embodiment assigns the arrival cost which is the relative weighting to each link. The server device 20 determines the selected node and the selected link based on the vehicle information on the target vehicle, the route information on the target vehicle, and the arrival costs.

Even when a link is different from the link on which the target vehicle is traveling, as the distance between the link on which the target vehicle is traveling and the different link becomes shorter, it is predicted that necessity for considering the road state information on the different link increases for the assistance control for the target vehicle. Thus, as in the autonomous travel assistance device according to the second embodiment, it is possible to more appropriately execute the autonomous travel assistance for the target vehicle by considering the arrival costs when the selected node and the selected link are to be determined.

Moreover, in the autonomous travel assistance device 10 according to the second embodiment, the arrival cost is determined to correspond to the time required for the target vehicle to move between two nodes to which each link is connected. Thus, the autonomous travel assistance for the target vehicle can more appropriately be executed.

Moreover, in the autonomous travel assistance device 10 according to the second embodiment, the arrival cost is determined to correspond to the distance of each link. Thus, the autonomous travel assistance for the target vehicle can more appropriately be executed.

Moreover, in the autonomous travel assistance device 10 according to the second embodiment, the selected link is a group of links that has a total value of the arrival costs of the links in the selected link that is equal to or smaller than the determination value. Thus, the autonomous travel assistance for the target vehicle can more appropriately be executed.

The total value of the arrival costs is the simple integrated value of the arrival costs, but the total value of the arrival costs may be a square sum of the arrival costs, or the arrival costs may be integrated by another method.

Moreover, the arrival cost is the cost which is calculated based on the average movement time required to move between two nodes and the distance between the two nodes, but that may be calculated in consideration of weather, a road surface state, and other fluctuating factors in addition to the time and the distance.

### Third Embodiment

Description is now given of an autonomous travel assistance device according to a third embodiment of this disclosure. In the autonomous travel assistance device according to the third embodiment, description is given of an example of the autonomous travel assistance in a case in which the target vehicle turns right or left at an intersection. A configuration of the autonomous travel assistance device according to the third embodiment is the same as those of the autonomous travel assistance device 10 according to the first embodiment and the autonomous travel assistance device 10 according to the second embodiment.

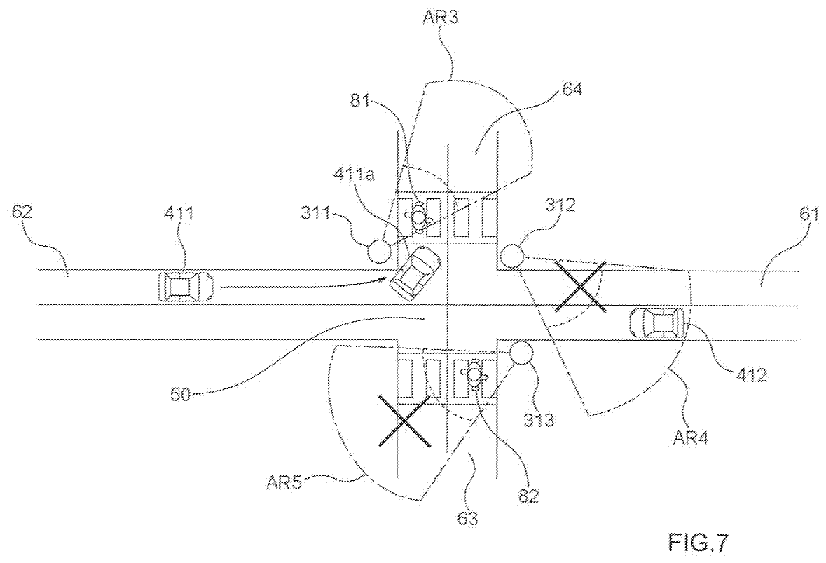

FIG. 7 is a view for illustrating an example of control executed by the autonomous travel assistance device according to the third embodiment. In FIG. 7, there are illustrated, the intersection 50 as a node, and the four roads 61, 62, 63, and 64 as links connected to the intersection 50. The four roads 61, 62, 63, and 64 are the roads having two lanes for left-hand driving.

Moreover, roadside units 311, 312, and 313 are installed at respective three locations of four corners of the intersection 50. A detectable area AR3 of a sensor of the roadside unit 311 is an area which is a part of the road 64. A detectable area AR4 of a sensor of the roadside unit 312 is an area which is a part of the road 61. A detectable area AR5 of a sensor of the roadside unit 313 is an area which is a part of the road 63.

A vehicle 411 is traveling on the road 62 toward the intersection 50, and the vehicle 412 is traveling on the road 61 toward the intersection 50. The vehicle 411 is a vehicle which can execute the autonomous travel, and is a vehicle which is a target of the autonomous travel assistance. The vehicle 411 is planned to turn left at the intersection 50 afterward, and then travel on the road 64. A vehicle 411a represents the vehicle 411 in the future which travels on the planned travel route.

The vehicle 412 is traveling toward the direction opposite to that of the vehicle 411, and is also approaching the vehicle 411. Such a vehicle is hereinafter referred to as “oncoming and approaching vehicle.”

Moreover, in FIG. 7, a pedestrian 81 is crossing the road 64, and a pedestrian 82 is crossing the road 63.

Although illustration is omitted in FIG. 7, the server device 20 receives the road state information within the detectable area AR3 from the roadside unit 311. Thus, the road state information from the roadside unit 311 includes information on the pedestrian 81. The server device 20 receives the road state information within the detectable area AR4 from the roadside unit 312. Thus, the road state information from the roadside unit 312 includes information on the vehicle 412.

The server device 20 receives the road state information within the detectable area AR5 from the roadside unit 313. Thus, the road state information from the roadside unit 313 includes information on the pedestrian 82. Moreover, the server device 20 receives, from the vehicle 411, the vehicle information on the vehicle 411 and the travel route of the vehicle 411.

The server device 20 holds the route information on the vehicle 411. Moreover, the server device 20 receives the vehicle information on the vehicle 411.

The server device 20 selects, as the selected links, a link corresponding to the road 62 and a link corresponding to the road 64. The server device 20 transmits, to the vehicle 411 as the dynamic map information, information obtained by adding road state information on the selected links to the map information stored in the server device 20.

As a result, a control unit of the vehicle 411 recognizes the existence of the pedestrian 81 crossing the road 64, and hence the vehicle 411, as the vehicle 411a does, stops before the pedestrian 81. As described above, when the target vehicle turns left on the road for left-hand driving, only the link which is on the travel route among the links connected to the node at which the target vehicle arrives next is selected as the selected link. When a target vehicle turns right on a road for right-hand driving, only a link which is on the travel route is similarly selected as the selected link.

That is, when the vehicle 411, which is the target vehicle, is traveling on a link and is planned to turn right or to turn left at the node at which the vehicle 411 arrives next, the server device 20 transmits, to the vehicle 411 as the dynamic map information, road state information on the link which is connected to the node at which the vehicle 411 arrives next and exists on a direction toward which the vehicle 411 turns.

With this configuration, unnecessary road state information is not transmitted to the target vehicle, and hence the autonomous travel assistance can more appropriately be executed.

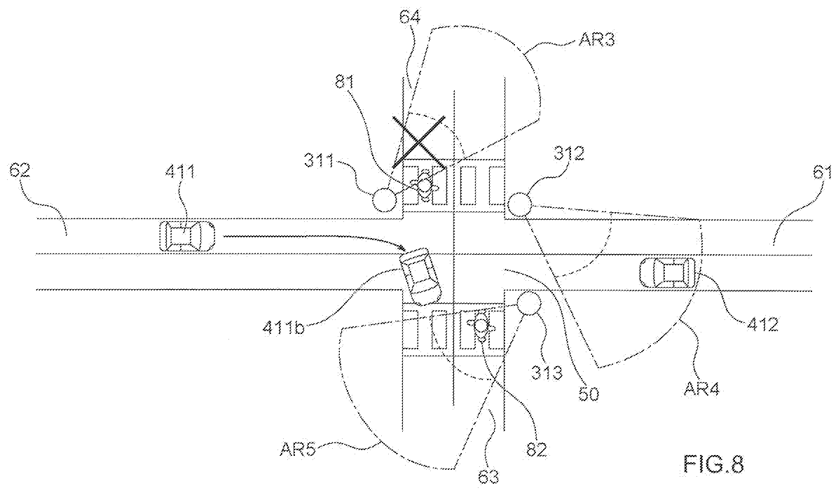

FIG. 8 is a view for illustrating an example of the control executed by the autonomous travel assistance device according to the third embodiment. FIG. 8 is a view for illustrating a case in which the vehicle 411 is planned to turn right at the intersection 50. A configuration other than such a point that the vehicle 411 is planned to turn right is the same as that of FIG. 7.

In this example, the server device 20 selects, as the selected links, a link corresponding to the road 62, a link corresponding to the road 63, and a link corresponding to the road 61. The server device 20 transmits, to the vehicle 411 as the dynamic map information, information obtained by adding road state information on the selected links to the map information stored in the server device 20.

As a result, the control unit of the vehicle 411 recognizes the existence of the pedestrian 82 crossing the road 63, and recognizes the existence of the vehicle 412 traveling on the road 61 and approaching the vehicle 411. The vehicle 411, as a vehicle 411b does, stops immediately before the pedestrian 82.

As described above, when the target vehicle turns right on the road for left-hand driving, and an oncoming and approaching vehicle exists, among the links connected to the node at which the target vehicle arrives next, the link which exists on the travel route and the link corresponds to the road on the extension of the road on which the target vehicle is currently traveling are selected as the selected links. Moreover, a link which exists on the direction toward which the vehicle 411 turns is also selected as the selected link. The same applies to a case in which a target vehicle turns left on a road for right-hand driving.

That is, when the vehicle 411, which is the target vehicle, is traveling on a link, and is planned to turn right or left at a node at which the vehicle 411 arrives next, and the planned travel route of the vehicle 412, which is the oncoming and approaching vehicle, and the planned travel route of the vehicle 411 cross, the server device 20 transmits the vehicle information on the vehicle 412 to the vehicle 411 as the dynamic map information.

With this configuration, unnecessary road state information is not transmitted to the target vehicle, and hence the autonomous travel assistance can more appropriately be executed.

When one or more vehicles are traveling in a direction opposite to the travel direction of the target vehicle, and are traveling toward a direction away from the target vehicle, the server device 20 is not required to transmit, to the target vehicle, the information on positions of the one or more vehicles and the travel states of the one or more vehicles.

As a result, the unnecessary information is further reduced, and hence the server device 20 can execute more appropriate autonomous travel assistance.

Moreover, in the first to third embodiments, the MEC is used as the server device 20, but the server device 20 is not particularly limited to the MEC.

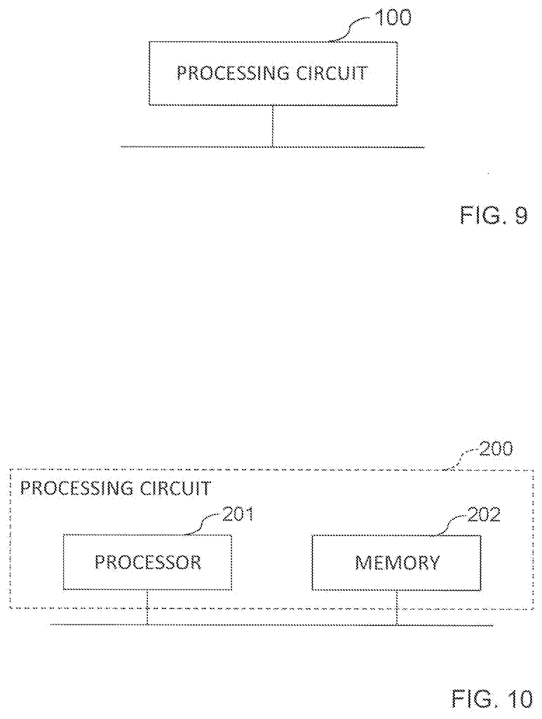

Moreover, the functions of the autonomous travel assistance device according to the first to third embodiments are implemented by a processing circuit. FIG. 9 is a configuration diagram for illustrating a first example of the processing circuit that implements the functions of the autonomous travel assistance device according to the first to third embodiments. A processing circuit 100 in the first example is dedicated hardware.

Further, the processing circuit 100 corresponds to, for example, a single circuit, a complex circuit, a programmed processor, a processor for a parallel program, an application specific integrated circuit (ASIC), a field programmable gate array (FPGA), or a combination thereof.

Further, FIG. 10 is a configuration diagram for illustrating a second example of a processing circuit that implements the functions of the autonomous travel assistance device according to the first to third embodiments. A processing circuit 200 of the second example includes a processor 201 and a memory 202.

In the processing circuit 200, the functions of the autonomous travel assistance device are implemented by software, firmware, or a combination of software and firmware. The software and the firmware are described as programs to be stored in the memory 202. The processor 201 reads out and execute the programs stored in the memory 202, to thereby implement the respective functions.

The programs stored in the memory 202 can also be regarded as programs for causing a computer to execute the procedure or method of each of the above-mentioned units. In this case, the memory 202 corresponds to, for example, a nonvolatile or volatile semiconductor memory, such as a random access memory (RAM), a read only memory (ROM), a flash memory, an erasable programmable read only memory (EPROM), or an electronically erasable and programmable read only memory (EEPROM). Further, a magnetic disk, a flexible disk, an optical disc, a compact disc, a MiniDisc, a DVD, or the like may also correspond to the memory 202.

The function of the autonomous travel assistance device described above may be implemented partially by dedicated hardware, and partially by software or firmware.

In this way, the processing circuit can implement the functions of the autonomous travel assistance device described above by hardware, software, firmware, or a combination thereof.

### REFERENCE SIGNS LIST

10 autonomous travel assistance device, 20 server device, 24 control unit, 25 dynamic map transmission unit, 26 storage unit, 30 roadside unit, 31 communication unit, 32 control unit, 33 sensor, 40 vehicle (target vehicle), 41 communication unit, 42 control unit, 43 storage unit, 50 intersection (node), 61 to 64 road (link), 311 to 313 roadside unit, 401 to 408, 411, 412 vehicle, L1 to L13 link, N1 to N9 node

1. An autonomous travel assistance device, comprising a server device configured to receive, from a roadside unit, road state information that is information on a state of a periphery of the roadside unit, and to transmit dynamic map information that is information obtained by adding the road state information to map information, to a target vehicle that autonomously travels along a planned travel route,
wherein the server device stores the map information as a combination of a plurality of nodes and a plurality of links,
wherein each of the plurality of nodes corresponds to an intersection,
wherein each of the plurality of links corresponds to a road connecting between two intersections next to each other, and
wherein the server device is configured to:
hold route information that is information on the travel route;
receive, from the target vehicle, vehicle information that is information on a position of the target vehicle and information on a travel state of the target vehicle;
select, as a selected node, a part of the plurality of nodes based on the vehicle information and the route information, and select, as a selected link, a part of the plurality of links based on the vehicle information and the route information; and
transmit, to the target vehicle as the dynamic map information, information obtained by adding the road state information on the selected node and the selected link to the map information.

2. The autonomous travel assistance device according to claim 1,
wherein each of the plurality of links has an arrival cost that is relative weighting to the each of the plurality of links added thereto, and
wherein the server device is configured to determine the selected node and the selected link based on the vehicle information, the route information, and the arrival cost.

3. The autonomous travel assistance device according to claim 2, wherein the arrival cost is determined to correspond to a time required for the target vehicle to move between two nodes to which the each of the plurality of links is connected.

4. The autonomous travel assistance device according to claim 2, wherein the arrival cost is determined to correspond to a distance of the each of the plurality of links.

5. The autonomous travel assistance device according to claim 1, wherein the selected link is a group of links that has a total value of the arrival costs of the links in the selected link that is equal to or smaller than a determination value.

6. The autonomous travel assistance device according to claim 1, wherein the server device is configured to avoid transmitting, to the target vehicle, information that is on positions and travel states of one or more vehicles and is received from the one or more vehicles, the one or more vehicles being vehicles traveling toward a direction away from the target vehicle among one or more vehicles traveling on the planned travel route toward a direction opposite to a travel direction of the target vehicle.

7. The autonomous travel assistance device according to claim 1, wherein, when the target vehicle is traveling on one of the plurality of links, and is planned to turn right or to turn left at one of the plurality of nodes at which the target vehicle arrives next, the server device is configured to transmit, to the target vehicle as the dynamic map information, the road state information on one of the plurality of links that is connected to the one of the plurality nodes at which the target vehicle arrives next and exists in a direction of the turn of the target vehicle.

8. The autonomous travel assistance device according to claim 1, wherein, when the target vehicle is traveling on one of the plurality of links, and is planned to turn right or to turn left at one of the plurality of nodes at which the target vehicle arrives next and a planned travel route of oncoming and approaching vehicles that are one or more vehicles traveling toward a direction opposite to a direction of the target vehicle and approaching the target vehicle and the planned travel route of the target vehicle intersect with each other, the server device is configured to transmit the vehicle information on the oncoming and approaching vehicles to the target vehicle as the dynamic map information.

9. The autonomous travel assistance device according to claim 1, wherein the server device is configured to hold the route information in association with lane information that is information on a lane of the road.

10. The autonomous travel assistance device according to claim 1,
wherein, when the target vehicle is traveling on one link of the plurality of links, the selected link is the one link on which the target vehicle is currently traveling and one or more links that are different from the one link, are connected to the one link, and are connected to one of the plurality of nodes at which the target vehicle arrives next, and the selected node is one of the plurality of nodes which is connected to the one link on which the target vehicle is currently traveling and at which the target vehicle arrives next, and
wherein, when the target vehicle is traveling on one node of the plurality of nodes, the selected link is a link that is connected to the one node on which the target vehicle is currently traveling and is different from one of the plurality of links which the target vehicle has passed, and the selected node is the one node on which the target vehicle is currently traveling.
